(19) United States
(12) Patent Application Publication
(10) Pub. No.: US 2026/0194706 A1
(43) Pub. Date: Jul. 9, 2026

(54) METHOD AND DEVICE FOR PREPARING SEMICONDUCTOR THREE-DIMENSIONAL MICRO/NANOSTRUCTURES WITH TUNABLE BANDGAP AND SEMICONDUCTOR THREE-DIMENSIONAL MICRO/NANOSTRUCTURE

(71) Applicant: China University of Geosciences, Wuhan, Hubei (CN)

(72) Inventors: Jing Zhang, Hubei (CN); Yao Wang, Hubei (CN); Ziyi Ding, Hubei (CN); Tianye Huang, Hubei (CN); Xiangyun Hu, Hubei (CN)

(73) Assignee: China University of Geosciences, Wuhan, Hubei (CN)

(21) Appl. No.: 19/096,737

(22) Filed: Apr. 1, 2025

(30) Foreign Application Priority Data
Jan. 9, 2025 (CN) 202510035332.1

(51) Int. Cl. G02B 6/02; C03B 37/014; G02B 1/00

(52) U.S. Cl. CPC G02B 6/0239; C03B 37/0146; G02B 1/005; G02B 6/02309

(57) ABSTRACT

The present disclosure belongs to the field of semiconductor device manufacturing technology, specifically disclosing a method for preparing semiconductor three-dimensional micro/nanostructures with tunable bandgap, including: heating a semiconductor-core optical fiber, and controlling the cooling rate, wherein the heating process and cooling rate have a corresponding relationship with the stress applied to the semiconductor three-dimensional micro/nanostructure, and this stress can tune the bandgap. In the situation where the target heating temperature is higher than the melting point of the fiber core, heating the optical fiber partially to apply controllable compressive stress to form a semiconductor three-dimensional micro/nanostructure and tune its bandgap. In the situation where the target heating temperature is lower than the melting point of the fiber core, heating the whole optical fiber to recrystallize the semiconductor three-dimensional micro/nanostructure, and using the volume mismatch to apply tensile stress to the semiconductor three-dimensional micro/nanostructure and tune its bandgap.

### CROSS-REFERENCE TO RELATED APPLICATION

This application claims the priority benefit of China application serial no. 202510035332.1, filed on Jan. 9, 2025. The entirety of the above-mentioned patent application is hereby incorporated by reference herein and made a part of this specification.

### BACKGROUND

### Technical Field

The present disclosure pertains to the field of semiconductor device manufacturing technology, and more specifically, relates to a method for fabricating a semiconductor three-dimensional micro/nanostructure with tunable bandgap.

### Description of Related Art

In recent years, despite the widespread application and research of silicon photonics in integrated circuits, existing silicon-based materials have been severely limited in terms of technological advancements and performance improvements for future devices, resulting in a current lack of suitable semiconductor material devices. Semiconductor materials and devices thereof form the foundation supporting multiple critical technologies, including electronics, computing, communications, optoelectronics, and sensing. The bandgap structure of semiconductors is a crucial factor determining their electrical and optical properties. In the current development of electrical and optical technologies, there is a desire not only to modulate the characteristics of semiconductors but also to miniaturize the corresponding devices.

To address the limitations of semiconductors in optoelectronic performance, researchers have introduced strain modulation techniques. By precisely controlling the type and magnitude of strain, it is possible to alter the crystal structure of semiconductor materials, thereby enabling the tuning of semiconductor bandgaps. However, the current technological approaches based on strain engineering for bandgap modulation not only involve complex operational procedures and high costs but are also limited in functionality, typically achieving either a reduction or an increase in bandgap, but not both simultaneously. Furthermore, the samples prepared using these techniques are relatively large in volume, making them difficult to align with the high-density integration requirements of electronic devices. In recent years, as research into strain modulation of two-dimensional materials has intensified, researchers have approached the limits at various levels. Nevertheless, influenced by Moore's Law, three-dimensional integration technology is expected to gradually evolve, paving the way for the exploration of three-dimensional materials. Strain modulation techniques for three-dimensional materials show promise in overcoming the limitations of two-dimensional materials in strain control, potentially achieving more efficient and flexible bandgap modulation. The pressing technical challenge in this field is to develop a method for conveniently fabricating semiconductor three-dimensional micro/nanostructures and precisely controlling their bandgaps. This advancement is crucial for addressing the current limitations and advancing semiconductor technology.

### SUMMARY

The purpose of the present disclosure is to achieve convenient preparation of semiconductor three-dimensional micro/nanostructures and precise regulation of the bandgap of semiconductor three-dimensional micro/nanostructures, in response to the deficiencies in the existing technology.

To achieve the above-mentioned purpose, in a first aspect, the present disclosure provides a method for preparing a semiconductor three-dimensional micro/nanostructure with tunable bandgap, which includes the following steps.

An optical fiber is heated according to the target heating temperature, and the cooling rate of the optical fiber during cooling is controlled. The heating process and cooling rate have a corresponding relationship with the stress applied to the fiber core and related semiconductor three-dimensional micro/nanostructure when heating the optical fiber. This stress can be used to tune the semiconductor bandgap.

In the situation where the target heating temperature is higher than the melting point of the fiber core, the optical fiber is partially heated to apply controllable compressive stress to the fiber core and form a semiconductor three-dimensional micro/nanostructure, and the bandgap structure thereof is tuned. In the situation where the target heating temperature is lower than the melting point of the fiber core, the whole optical fiber is heated to recrystallize the semiconductor three-dimensional micro/nanostructure, and the volume difference between the recrystallized structure and the original structure is utilized to apply tensile stress to the semiconductor three-dimensional micro/nanostructure, and the bandgap structure thereof is tuned.

The heating process can be performed by heating the optical fiber partially when the target heating temperature is higher than the melting point of the fiber core, for example, heating the target area through a first heating source (which will be explained in detail later). The heating process can also be performed by heating the whole optical fiber when the target heating temperature is lower than the melting point of the fiber core, for example, heating the whole optical fiber processed by the first heating source through a second heating source (which will be explained in detail later).

The principle of preparing semiconductor three-dimensional micro/nanostructures is based on the difference in absorption coefficients of the fiber core (semiconductor material) and cladding to the heating source. The energy of the heating source is mainly absorbed by the semiconductor material, and the absorbed energy causes the fiber core to begin liquefying. Under the action of capillary instability, the surface tension and viscoelastic forces between the fiber core and cladding work together, causing the liquefied cylindrical fiber core to break up into multiple droplets within the cladding. Under specific temperature and stress conditions, these droplets can form spherical, ellipsoidal, or rod-shaped micro/nanostructures, which mainly depend on the thermal expansion characteristics of the optical fiber, the stress distribution during the heating process, and the initial shape of the optical fiber. When the optical fiber is uniformly heated, the semiconductor material inside is subjected to uniform stress in all directions, thus forming stable spherical droplets. However, when the optical fiber is subjected to non-uniform heating or non-uniform stress distribution (non-uniform movement of the optical fiber might produce non-uniform stress distribution), the interior of semiconductor material has greater stress in one direction, which might lead to the formation of ellipsoidal or rod-shaped fiber cores. Finally, as the heating source moves away from the optical fiber, the cladding and semiconductor droplets begin to solidify successively, thus forming semiconductor three-dimensional micro/nanostructures inside the cladding.

The principle of regulating the bandgap of semiconductor three-dimensional microstructures can be achieved through precisely controlling the cooling rate of thermal treatment for optical fiber, thereby affecting the internal thermal stress and degree of crystal crystallization of the semiconductor material. During the thermal treatment process of the optical fiber, different types and magnitudes of internal stress can be generated in the semiconductor material due to different cooling rates. These internal stresses can affect the crystal structure of the semiconductor material, thereby influencing the band structure, to achieve the purpose of tunable bandgap.

Specifically, the generation of thermal stress in semiconductor materials results from the difference in thermal expansion coefficients between the fiber core and cladding, leading to volume mismatch. Some materials (such as silicon and germanium) exhibit solidification expansion during the liquid-to-solid phase transition. Moreover, the melting point of the fiber core (semiconductor material) is lower than the softening point of the cladding (such as silica).

In the first situation, the heating source heats the fiber core to a molten state. When the optical fiber begins to cool, the silica cladding solidifies first and forms a fixed cavity, the volume of which is determined by the cooling rate. The faster the cooling rate, the lower the density of silica, and the smaller the fixed cavity formed. Subsequently, the semiconductor material reaches its solidification temperature (melting point) and transitions from liquid to solid state. During the cooling process, due to solidification expansion of the semiconductor material, its volume begins to increase, thus being restricted and compressed by the surrounding cladding. This volume mismatch causes compressive stress to generate within the semiconductor material. The cooling rate mainly affects the volume of the cladding when it solidifies, thereby affecting the magnitude of internal stress in the semiconductor material. A faster cooling rate can cause the cladding to retain its material characteristics at high temperatures, resulting in a larger volume, which further restricts the space for the semiconductor material, causing greater compressive stress to generate therein.

In the second situation, the heating source can only moderately heat the cladding of the optical fiber without reaching the molten state, and the heating temperature is lower than the melting point of the fiber core. Under these conditions, the semiconductor material can mainly undergo a low-temperature recrystallization process. During the heating and cooling process of the optical fiber, due to the distribution of temperature gradients, the semiconductor crystal can begin to recrystallize. In the process of crystal crystallization, new crystal orientations can be formed gradually, internal defects can be eliminated or reduced, and the internal structure can begin to rearrange, forming a more compact and ordered crystal structure. However, the cladding hardly deforms and the tightly packed crystal structure is forced to occupy the same cavity volume. Therefore, this volume mismatch can cause tensile stress to be generated within the semiconductor material. The cooling rate has a direct impact on the crystallization time of the crystal, the degree of crystallization, and the alignment density, thereby affecting the volume mismatch phenomenon and the magnitude of tensile stress in the semiconductor material. In practical applications, the situation is often more complex than in theory, and it is not possible to analyze only one situation in isolation.

In a possible implementation mode, the heating of the optical fiber according to the target heating temperature, and controlling the cooling rate when cooling the optical fiber, can include the following steps.

The target area is heated by a first heating source, and during the heating process, the optical fiber enters and leaves the target area according to the target moving speed, to make the fiber core form into the semiconductor three-dimensional micro/nanostructure. The target area and the optical fiber are located in the same horizontal plane. The target heating temperature specifically refers to the temperature at the center of the target area, which is higher than the melting point of the fiber core. The optical fiber has a first cooling rate in the process of leaving the target area.

The first heating source can select a laser as a high-energy light source to ensure that the fiber core can reach the melting point. By adjusting the laser power, a sufficient heating temperature can be obtained. By adjusting the height of the laser, the size of the laser spot can be changed. By adjusting the size of the laser spot, the cooling rate of thermal treatment for the optical fiber can be further controlled. The size of the laser spot determines the area of the optical fiber irradiated by the laser (i.e., the aforementioned target area). Under the situation where other variables remain constant, the larger the spot size, the larger the area irradiated by the laser, the smaller the temperature gradient of the heated portion of the optical fiber, and the slower the cooling rate of the thermal treatment. Therefore, the cooling rate of the optical fiber can be regulated according to different laser spot sizes. When the spot size is large, the cooling rate is slow, and when the spot size is small, the cooling rate is fast.

In a possible implementation mode, in a situation where the first heating source conducts uniform heating to the target area, the shape of the semiconductor three-dimensional micro/nanostructure can be spherical.

In a situation where the first heating source conducts non-uniform heating to the target area, the shape of the semiconductor three-dimensional micro/nanostructure can be non-spherical.

In a possible implementation mode, the first heating source can be a laser, and before heating the target area through the first heating source, the method can further include the following step.

The height of the laser is adjusted to determine the spot size formed by the laser emitted from the laser in the target area. The spot size affects the cooling rate, where a smaller spot size results in a faster first cooling rate.

In a possible implementation mode, the method can further include the following steps.

An image of the optical fiber in the target area is acquired.

An image is displayed and a target input is received, wherein the image is used to calculate and quantify a numerical value of the cooling rate utilizing the blackbody radiation principle, and the target input is used to indicate an adjustment amount of the moving speed and an adjustment amount of the laser power.

In response to the target input, based on the adjustment amount of the moving speed and the adjustment amount of the laser power, the target moving speed of the optical fiber and the laser power are controlled.

In a possible implementation mode, the method can further include the following steps.

Through a moving stage carrying the optical fiber (horizontally or vertically placed optical fiber), the moving stage can be used to carry the optical fiber and move it at a target speed during the process of heating the target area by the first heating source.

In a possible implementation mode, the heating of the optical fiber according to the target heating temperature and controlling the cooling rate when cooling the optical fiber can include the following steps.

Through a second heating source, the optical fiber processed by the first heating source can be heated overall to recrystallize the semiconductor three-dimensional micro/nanostructure in the cladding. The target heating temperature provided by the second heating source for the optical fiber is lower than the melting point of the fiber core. The overall heating process includes a temperature rising stage from a preset temperature to the target heating temperature, a temperature maintaining stage, and a temperature decreasing stage from the target heating temperature to the preset temperature. The temperature decreasing stage has a second cooling rate.

The second heating source can be selected as a tubular furnace, through setting the cooling rate inside the furnace to achieve regulation of the cooling rate of the optical fiber. However, the heating mode of the tubular furnace is different from that of the laser. The laser can heat the optical fiber partially, which is difficult for the tubular furnace to achieve. Therefore, the laser is suitable for preparing semiconductor three-dimensional micro/nanostructures and tuning the bandgap, while the tubular furnace is suitable for tuning the bandgap, but not suitable for preparing semiconductor three-dimensional micro/nanostructures.

A tubular furnace can simultaneously satisfy the requirements for placing and heating semiconductor three-dimensional micro/nanostructures, and can adjust the temperature inside the furnace according to the target furnace temperature, heating and cooling rate, and holding time in a vacuum environment.

Specifically, the temperature inside the furnace is the recrystallization temperature of the fiber core, which needs to be set below the melting point of the semiconductor material to ensure that the material does not melt and is suitable for crystal recrystallization. The heat preservation time needs to be set sufficiently to allow the fiber core to be fully affected by thermal stress and to allow enough time for crystal growth and rearrangement. The cooling rate, which is the cooling rate of the optical fiber, will affect the degree of crystallization of the semiconductor crystal. Therefore, an appropriate rate needs to be selected to ensure that internal stress can still be retained after cooling.

In a possible implementation mode, the second heating source can be a tubular furnace.

The tubular furnace is utilized to hold the optical fiber containing semiconductor three-dimensional micro/nanostructures after being processed by the first heating source, and in a vacuum environment, the temperature inside the furnace is adjusted according to the target furnace temperature, heating rate, cooling rate, and holding time, where the target furnace temperature is the target heating temperature, and the cooling rate is the second cooling rate.

In a second aspect, the present disclosure further provides a device for preparing semiconductor three-dimensional micro/nanostructures with tunable bandgap, including: a carrier and a heating module.

The carrier is configured for placing the optical fiber.

The heating module is provided to heat the optical fiber according to the target heating temperature, and control the cooling rate when the optical fiber is cooled. The heating process and cooling rate have a corresponding relationship with the stress applied to the fiber core and related semiconductor three-dimensional micro/nanostructure during heating of the optical fiber. This stress can be used to tune the semiconductor bandgap.

In the situation where the target heating temperature is higher than the melting point of the fiber core, the optical fiber is partially heated to apply controllable compressive stress to the fiber core, forming a semiconductor three-dimensional micro/nanostructure and tuning the bandgap structure thereof. In the situation where the target heating temperature is lower than the melting point of the fiber core, the whole optical fiber is heated to recrystallize the semiconductor three-dimensional micro/nanostructure, utilizing the volume difference between the recrystallized structure and the original structure to apply tensile stress to the semiconductor three-dimensional micro/nanostructure, and tuning the bandgap structure thereof.

In a possible implementation mode, the carrier can specifically be a moving stage, and the heating module can include a heating source and a controller (such as a control computer), with the heating source and the moving stage respectively connected to the controller.

The heating source is utilized to provide the optical fiber with the necessary heat and corresponding cooling rate.

The moving stage is utilized for placing the optical fiber and carrying the optical fiber to move.

The controller is utilized to control the moving speed of the optical fiber, and is responsible for setting and adjusting the device parameters of the heating source.

It should be noted that if the heating source has mobility, the moving stage can also be any stage capable of holding the optical fiber.

Specifically, the controller regulates the moving stage according to the required heating length of the optical fiber and the moving speed, and adjusts the laser power according to the melting points of the fiber core and cladding, to ensure that the fiber core has sufficient heating time and heating temperature to reach a molten state.

It can be understood that by introducing the optical fiber into the laser irradiation area and performing partial heating, and by adjusting the moving speed of the optical fiber and the laser power, the fiber core can reach the melting point, forming different semiconductor three-dimensional micro/nanostructures. By adjusting the size of the laser spot, the compressive stress applied to the semiconductor three-dimensional micro/nanostructure can be further regulated. In addition, by placing the optical fiber containing the semiconductor three-dimensional micro/nanostructure into a tubular furnace and conducting a low-temperature recrystallization process, corresponding tensile stress can be applied. This compressive stress and tensile stress can change the band structure of the semiconductor, thereby achieving bandgap tuning of the semiconductor three-dimensional micro/nanostructure.

Therefore, through the preparation device composed of a heating source, a moving stage, and a controller, semiconductor three-dimensional micro/nanostructures can be conveniently prepared. By adjusting the cooling rate of the thermal treatment for the optical fiber, the bandgap of the semiconductor three-dimensional micro/nanostructures can be regulated.

In a possible implementation mode, the optical fiber can have a semiconductor material as the fiber core.

In a possible implementation mode, the device can further include: a camera, wherein the camera is connected to the controller.

The camera is provided to capture images of the optical fiber at the light output position, and send the captured images to the controller.

The controller is specifically utilized to display images and make corresponding adjustments to the moving speed and laser power.

Specifically, the position and focal length of the camera can be adjusted to make the camera vertically aligned with the laser output position, for observing the temperature distribution situation of the optical fiber during heating; the controller can also be utilized to adjust the image parameters of the camera.

Through the collected images, it can be observed that a solid-liquid alternating interface appears in the heating area of the optical fiber, indicating that the optical fiber has reached the conditions for preparation. The image can also be used to calculate the cooling rate of the optical fiber by utilizing the principle of blackbody radiation.

In a third aspect, the present disclosure further provides a semiconductor three-dimensional micro/nanostructure, wherein the semiconductor three-dimensional micro/nanostructure is prepared by applying the preparation method described in the first aspect or any possible implementation mode of the first aspect.

Overall, compared with the existing technology, the technical solutions conceived in the present disclosure have the following advantageous effects.
(1) A principle of preparing semiconductor three-dimensional micro/nanostructures with tunable bandgap is adopted, which can not only prepare various types of semiconductor three-dimensional micro/nanostructures, but also regulate the stress and bandgap of semiconductors. By changing the heating mode (uniform heating or non-uniform heating) of the heating source, it is possible to prepare micro/nanostructures with different shapes such as spherical, ellipsoidal, and rod-like. In addition, by controlling the heating process and cooling rate of the heating source, the thermal stress and degree of crystal crystallization of the semiconductor can be affected, thereby applying compressive stress and tensile stress to the semiconductor, which in turn affects the band structure thereof, thus achieving bandgap tunability.
(2) Through utilizing a laser to heat the optical fiber partially, by only using laser irradiation, and by adjusting the moving speed of the optical fiber, the laser spot size and power, it is possible to apply corresponding compressive stress to the semiconductor three-dimensional micro/nanostructure, thereby affecting the band structure of the semiconductor. For direct bandgap materials, compressive stress normally can lead to a reduction in the bandgap. This is because compressive stress can reduce the energy difference between the conduction band and the valence band, thus lowering the bandgap. For indirect bandgap materials, the effect of compressive stress can be more complex. In some situations, compressive stress can cause the bandgap to increase, because compressive stress can alter the position of energy valleys, making it more difficult for electrons to transition from the valence band to the conduction band.
(3) Through placing the optical fiber in a tubular furnace for low-temperature recrystallization treatment, as well as adjusting the furnace temperature, holding time, and heating/cooling rate of the tubular furnace, corresponding tensile stress can be applied to the semiconductor three-dimensional micro/nanostructure, thereby affecting the band structure of the semiconductor. For direct bandgap materials, tensile stress normally leads to an increase in the bandgap. This is because tensile stress increases the energy difference between the conduction band and valence band, thus increasing the bandgap. For indirect bandgap materials, the effect of tensile stress can be more complex. In some situations, tensile stress can lead to a decrease in the bandgap, as tensile stress can change the position of energy valleys, making it easier for electrons to transition from the valence band to the conduction band. The above process does not require any complex processes such as deposition, sputtering, or coating, nor does it rely on large and expensive equipment, simplifying the manufacturing process and reducing production costs.
(4) The semiconductor three-dimensional micro/nanostructures with tunable bandgap produced using the aforementioned preparation device and method can not only meet the demands for semiconductors with different bandgaps, but also, due to the tunability of these semiconductor three-dimensional micro/nanostructures, especially the selectable diameter of the spherical structures, they can be easily integrated with electronic devices and maintain good compatibility with conventional silicon-based devices.

### BRIEF DESCRIPTION OF THE DRAWINGS

FIG. 1 is a schematic diagram of a method for preparing semiconductor three-dimensional micro/nanostructures and adjusting the bandgap of semiconductor three-dimensional micro/nanostructures using a laser according to an embodiment of the present disclosure.

FIG. 2 is a Raman spectroscopy diagram of the germanium microspheres after laser-induced recrystallization according to an embodiment of the present disclosure.

FIG. 3 is a flowchart of a method for heating semiconductor three-dimensional micro/nanostructures using a tubular furnace and adjusting the bandgap of semiconductor three-dimensional micro/nanostructures according to an embodiment of the present disclosure.

FIG. 4 is a comparative Raman spectroscopy diagram of the germanium microspheres after laser-induced recrystallization and low-temperature recrystallization provided by an embodiment of the present disclosure.

FIG. 5 is a comparison diagram of photoluminescence spectra at room temperature for the germanium microspheres after laser-induced recrystallization and low-temperature recrystallization, as provided by an embodiment of the present disclosure.

FIG. 6 is an optical microscope image of an independent silicon microsphere provided by an embodiment of the present disclosure.

### DESCRIPTION OF THE EMBODIMENTS

In order to make the purpose, technical solution, and advantages of the present disclosure more comprehensible, the following description provides further details of the present disclosure in conjunction with the drawings and embodiments. It should be understood that the specific embodiments described here are only used to explain the present disclosure and are not intended to limit the present disclosure.

In this embodiment of the present disclosure, words such as “exemplary” or “for example” are used to indicate examples, illustrations or explanations. Any embodiment or design scheme described as “exemplary” or “for example” in this embodiment of the present disclosure should not be interpreted as more preferable or advantageous than other embodiments or design schemes. More precisely, the use of words such as “exemplary” or “for example” is intended to present relevant concepts in a specific manner.

In the description of the embodiments of the present disclosure, unless otherwise specified, “multiple” means two or more. For example, multiple processing units refer to two or more processing units; multiple elements refer to two or more elements, etc.

First, the technical terms involved in the embodiments of the present disclosure are described.
(1) Indirect bandgap semiconductor: In indirect bandgap semiconductors, the conduction band minimum and valence band maximum are not in the same Brillouin zone. When electrons transition from the conduction band to the valence band, they require the assistance of phonons (lattice vibrations) to satisfy the momentum conservation condition. This results in lower efficiency of light emission and absorption. Common indirect bandgap semiconductor materials include silicon, germanium, and indium arsenide.
(2) Direct bandgap semiconductors: In direct bandgap semiconductors, the conduction band minimum and valence band maximum are located in the same Brillouin zone. Electron transitions do not require the participation of phonons, resulting in higher efficiency of light emission and absorption. These semiconductors are suitable for optoelectronic devices, such as lasers and photodetectors. Common direct bandgap semiconductor materials include gallium arsenide, indium phosphide, gallium nitride, etc.
(3) Strain regulation technology: Strain regulation technology mainly achieves the regulation of material physical properties by changing the lattice structure and band structure of materials through applying strain. Strain types mainly include tensile strain and compressive strain. Common methods of applying strain include stretching or compressing materials through mechanical means, introducing strain by utilizing thermal expansion or contraction of materials during heating or cooling processes, and introducing strain in materials through chemical reactions (such as chemical vapor deposition). Using different strain methods or applying different types of strain can affect the band structure, electron mobility, carrier concentration, and other properties of materials differently.
(4) Band structure: The band structure of solid materials is composed of multiple energy bands, which are divided into conduction bands, valence bands, and forbidden bands, etc. The gap between the conduction band and valence band is called the forbidden band (bandgap).
(5) Semiconductor three-dimensional micro/nanostructure: A semiconductor material structure with dimensions at the micron or nanometer scale, formed through advanced microfabrication processes or material growth technologies, and possessing specific functions. These structures exhibit unique electronic, optical, and thermal properties through precise control of the size, shape, and surface characteristics of the material.

The following description of the embodiments of the present disclosure is provided in conjunction with the accompanying drawings of the embodiments of the present disclosure.

Embodiment 1 and Embodiment 2 are illustrated using a semiconductor-core optical fiber with pure germanium as the fiber core and aluminosilicate glass as the cladding. This special optical fiber is selected as an example mainly because its cladding and fiber core have similar melting points, which can effectively avoid the situation where the semiconductor three-dimensional micro/nanostructure inside the cladding cracks due to excessive stress, facilitating the subsequent acquisition of a complete semiconductor three-dimensional micro/nanostructure. According to actual application requirements, the cladding material is not limited to silica, but can also be silicate, borosilicate, phosphate, etc., and its physical characteristics can be adjusted by doping different substances. In addition to germanium, the fiber core can be other materials that need to be made into micro/nanostructures, such as silicon and other crystalline materials, ZnS, CdTe, ZnSe and other II-VI group materials, InSb, InP, InAs and other III-V group materials, gold, tin, lithium or other alloys. However, regardless of the materials of the cladding and fiber core, their thermal and mechanical characteristics should meet the requirements of the optical fiber melting and drawing process and the formation of semiconductor three-dimensional micro/nanostructures.

Embodiment 1: A device and method for controlling cooling rate using a laser to produce semiconductor three-dimensional micro/nanostructures and adjust the bandgap of semiconductor three-dimensional micro/nanostructures.

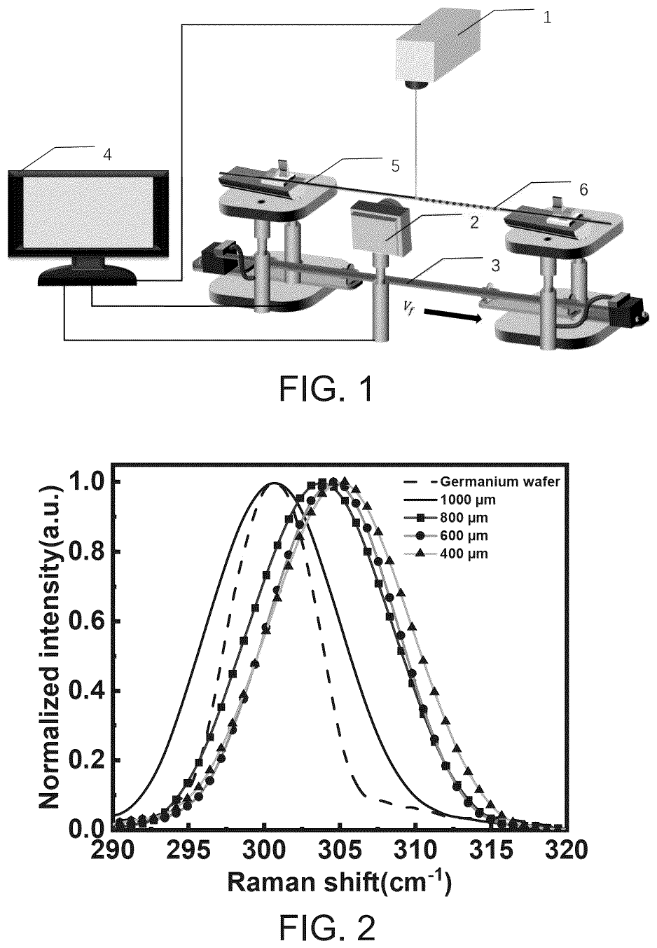

Referring to FIG. 1, the present disclosure provides a device for producing and adjusting semiconductor three-dimensional micro/nanostructures, including a laser 1, a camera 2, and a motorized moving stage 3, all of which are connected to a control computer 4. The motorized moving stage 3 is provided for placing a semiconductor-core optical fiber 5, adjusting the heating length and moving speed of the semiconductor-core optical fiber 5; the laser 1 is vertically placed above the motorized moving stage 3, changing the size of the laser spot by adjusting the height, and the emitted laser beam heats the semiconductor-core optical fiber 5 partially on the motorized moving stage 3; the camera 2 is positioned directly in front of the laser heating area, provided for observing the temperature distribution situation of the semiconductor-core optical fiber 5 during heating; the control computer 4 is utilized to regulate the moving distance and speed of the motorized moving stage 3, adjust the laser power 1 and the image parameters of the camera 2. In FIG. 1, V_{f} represents the moving speed of the optical fiber.

The working principle of using a laser to produce semiconductor three-dimensional micro/nanostructures is as follows. In this embodiment, the semiconductor-core optical fiber 5 is adopted. Due to the different absorption coefficients of the germanium core and cladding, the laser energy is mainly absorbed by the fiber core, and the absorbed laser energy liquefies the fiber core. Under the action of capillary instability, due to the surface tension and viscoelastic forces between the fiber core and cladding materials, the liquefied cylindrical fiber core splits into multiple droplets within the cladding. As the optical fiber moves away from the laser heating area, the cladding solidifies first due to its higher melting point than the fiber core, and then the spherical droplets gradually cool and solidify, as shown in FIG. 1, ultimately forming a solid-state semiconductor three-dimensional micro/nanostructure 6 with internal stress.

The working principle of using a laser to control the cooling rate and adjust the bandgap of semiconductor three-dimensional micro/nanostructures is as follows. By adjusting the height of the laser, the size of the laser spot can be changed. Through adjusting the size of the laser spot, the cooling rate of the thermal treatment of the optical fiber can be further controlled. The size of the laser spot determines the size of the area of the optical fiber irradiated by the laser. Under the situation where other variables remain unchanged, the larger the spot size, the larger the area irradiated by the laser, the smaller the temperature gradient of the heated part of the optical fiber, and the slower the cooling rate of the thermal treatment. Therefore, the cooling rate of the optical fiber can be regulated according to different laser spot sizes. When the spot size is large, the cooling rate is slow, and when the spot size is small, the cooling rate is fast. In the meantime, the glass transition temperature, density, and thermal expansion coefficient of the silica cladding decrease with a faster cooling rate. This is because a faster cooling rate reduces the time for liquid kinetic energy to convert to thermal energy, resulting in the structure of liquid glass (cladding material) being solidified at a higher temperature. Under extremely fast cooling rates, the silica cladding still maintains its material characteristics at high temperatures. At this time, the volume of the silica cladding is larger, which further reduces the space for micro/nanostructures to exist within the cladding, increasing the compressive stress of the semiconductor three-dimensional micro/nanostructure.

Based on the said principle, the method for producing semiconductor three-dimensional micro/nanostructures and adjusting the bandgap of semiconductor three-dimensional micro/nanostructures using a laser can include the following steps.

The semiconductor-core optical fiber 5 is horizontally placed on the motorized moving stage 3. First, a low-power red light is emitted from the laser 1 for calibration to ensure that the laser beam vertically irradiates the center of the optical fiber. Then, the height of the laser is adjusted to change the laser spot size, which can affect the cooling rate of the thermal treatment for the optical fiber, leading to changes in the internal stress of the semiconductor three-dimensional micro/nanostructure. The control computer 4 adjusts the laser power according to the melting point of the fiber core to ensure that the fiber core is able to melt. At the same time, the control computer 4 regulates the motorized moving stage 3 according to the required heating length and moving speed of the optical fiber to ensure that the optical fiber has sufficient heating time and temperature to form the semiconductor three-dimensional micro/nanostructure 6. After the parameters are set, the laser emits laser light, and the moving stage feeds the optical fiber into the laser heating area at the set speed.

Preferably, before production, through images captured by the camera, it can be determined whether a solid-liquid alternating interface appears in the heating area of the optical fiber. If so, it indicates that the laser power and moving speed are appropriate; if not, the laser power and moving speed need to be adjusted. Specifically, the position and focal length of camera 2 are adjusted, and when a solid-liquid alternating interface is observed in the heating area of the optical fiber through the camera 2, it indicates that an appropriate laser power has been reached, and a string of liquid droplets begins to form slowly. The image of this solid-liquid alternating interface not only shows the morphological changes of the optical fiber during thermal treatment but can also be used to accurately calculate the cooling rate of the optical fiber. By extracting the radiation intensity distribution from the image, the temperature distribution can be quantified using the principle of blackbody radiation, thereby plotting the temperature distribution curve of the optical fiber during thermal treatment and calculating the cooling rate. The blackbody radiation calculation formula is as follows:

$$M ( λ , T ) = {\frac{{c}_{1}}{{λ}^{5}} [ exp ( \frac{{c}_{2}}{λ T} ) ]}^{- 1} ;$$

wherein, c₁=2πhc² is the first radiation constant, c₂=hc/k is the second radiation constant. Through precisely controlling the cooling rate, the internal stress and bandgap of the semiconductor three-dimensional micro/nanostructure can be effectively regulated.

As the optical fiber gradually moves away from the heating area, the spherical liquid droplet solidifies to form a solid-state semiconductor three-dimensional micro/nanostructure 6.

Preferably, the compressive stress of the semiconductor can be regulated by solely changing the size of the laser spot, thereby affecting the bandgap. The moving speed of the optical fiber can be set to 10 μm/s, and while maintaining this moving speed unchanged, laser beams with different spot diameters can be used successively, which are 1000 μm, 800 μm, 600 μm, and 400 μm respectively. When changing laser beams with different spot diameters, it can also be necessary to adjust the laser power according to the melting point of the semiconductor-core.

The Raman spectrum of the germanium microspheres prepared by the said parameters is shown in FIG. 2. Compared with the Raman peak of the germanium wafer, the Raman peak shifts of the germanium microspheres prepared when the laser spot diameters are 1000 μm, 800 μm, 600 μm, and 400 μm are 0 cm⁻¹, 3.85 cm⁻¹, 4.59 cm⁻¹, and 5.33 cm⁻¹, respectively.

For germanium material, the relationship between the shift of the first-order Raman peak and pressure P is as follows:

$$d ω / dP = 3.9 \pm 0.2 {GPa}^{- 1} ;$$

Here, dω/dP is the first-order derivative, that is, the rate of change between ω and P.

In a situation where the deformation amount does not exceed a specific elastic limit of the corresponding material, the relationship between stress and strain can be as follows:

$$E = σ / ε ;$$

For germanium material, E is Young's modulus, which can be taken as 103 GPa, σ is stress, and ε is strain.

According to the calculation formula, the magnitudes of compressive stress of the above-mentioned germanium microspheres are 0, 0.99±0.07, 1.18±0.06, and 1.37±0.07 GPa, respectively. The magnitudes of the compressive strain are 0%, 0.96%±0.07%, 1.15%±0.06%, and 1.33%±0.07%, respectively.

Embodiment 2: A method for controlling the cooling rate using a tubular furnace to adjust the bandgap of semiconductor three-dimensional micro/nanostructures.

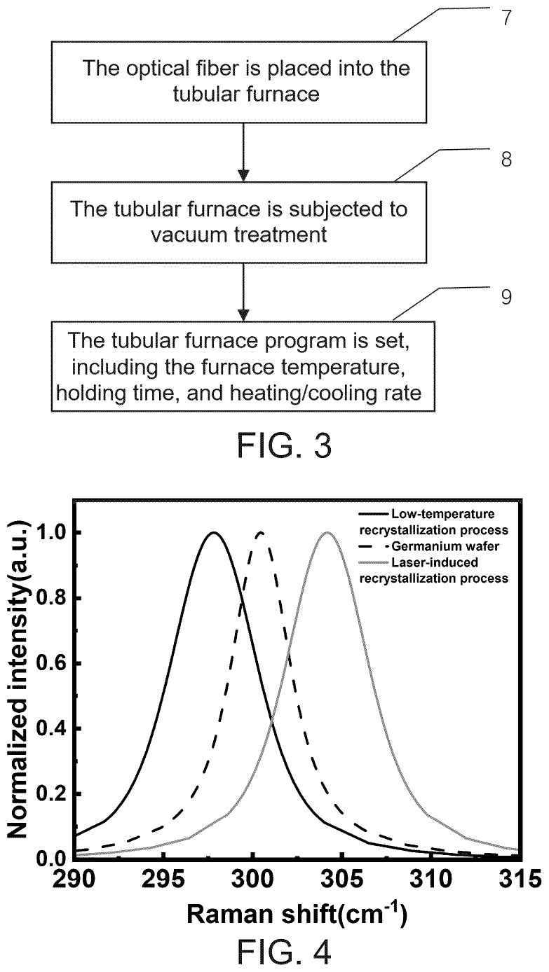

Based on the method described in Embodiment 1, referring to FIG. 3, this embodiment can include operations 7 to 9 for a method of regulating the bandgap of semiconductor three-dimensional micro/nanostructures using a tubular furnace.

In operation 7, the optical fiber is placed into the tubular furnace, wherein, due to the difficulty of directly securing the optical fiber inside the furnace, high-temperature resistant adhesive can be used to first fix the optical fiber on a glass slide to ensure its stability during the heating process.

In operation 8, the tubular furnace is subjected to vacuum treatment, wherein, due to the semiconductor material being prone to react with oxygen at high temperatures to generate oxides, to avoid this situation, it is necessary to ensure that the environment inside the tubular furnace is a vacuum, thus preventing oxidation of the semiconductor material.

In operation 9, the tubular furnace program is set, including the furnace temperature, holding time, and heating/cooling rate. These three parameters can all affect the low-temperature recrystallization process of the semiconductor.

Specifically, the temperature in the furnace is the recrystallization temperature of the semiconductor, which needs to be set below the melting point of the semiconductor material to ensure that the material does not melt. The holding time needs to be set sufficiently to allow the semiconductor to be fully affected by thermal stress and to allow enough time for crystal growth and rearrangement. The cooling rate is the rate of cooling the optical fiber, which affects the degree of crystallization of the semiconductor. Therefore, an appropriate cooling rate needs to be selected to ensure that the internal stress of the three-dimensional micro/nanostructure of the semiconductor can still be retained after cooling.

Preferably, the optical fiber processed according to Embodiment 1 can be transferred to a pure SiO₂ glass slide and fixed with high-temperature resistant adhesive. Then, the glass slide with the optical fiber can be placed in a tubular furnace, and the interior of the tubular furnace can be first vacuum-extracted. Subsequently, the tubular furnace can be set to heat at a specific heating rate, rising to a reaction temperature above 200° C., and maintained at this temperature for more than 1 hour. Afterwards, the temperature can be cooled to room temperature at a cooling rate lower than 10° C./min, which subjects the semiconductor three-dimensional micro/nanostructure to a low-temperature recrystallization process, generating tensile stress within the semiconductor three-dimensional micro/nanostructure, thereby further modifying the bandgap of semiconductor three-dimensional micro/nanostructure.

The Raman spectrum of the germanium microspheres prepared by Embodiment 2 is shown in FIG. 4. Compared with the Raman peaks of the germanium wafer and the germanium microspheres prepared by Embodiment 1, the Raman peak shifts of the germanium microspheres prepared by Embodiment 1 and Embodiment 2 are 3.73 cm⁻¹ and −2.63 cm⁻¹ (left shift is negative), respectively.

For germanium material, the calculation formula for the Raman peak shift Δω and the tensile strain magnitude ε is as follows:

$$ε = Δω / b ;$$

b is a linear coefficient, for example, b can be taken as −395 cm⁻¹.

According to the above calculation formula, the germanium microspheres prepared in Embodiment 1 and Embodiment 2 can be converted to corresponding stress and strain. The magnitudes of stress are compressive stress of 0.96±0.05 GPa and tensile stress of 0.69 GPa, respectively. The magnitudes of strain are compressive strain of 0.93%±0.05% and tensile strain of 0.67%, respectively.

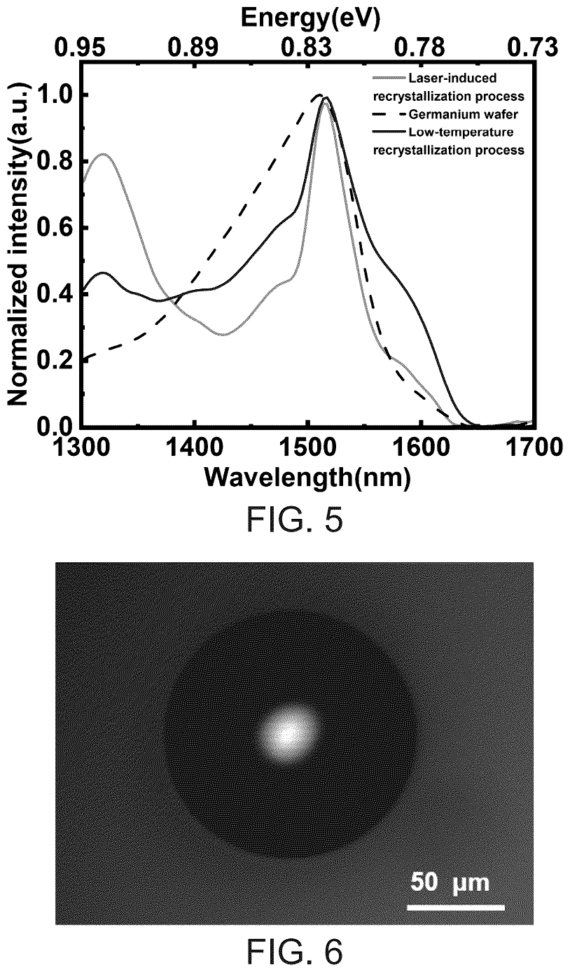

In order to characterize the effect of applied stress on semiconductor bandgap regulation, FIG. 5 shows a comparison of room temperature photoluminescence spectra of the germanium microspheres with compressive and tensile stress prepared by Embodiment 1 and Embodiment 2. With germanium as an indirect bandgap semiconductor, using the direct bandgap energy of 0.82 eV of the germanium wafer as a reference point, the characteristic peak values of the room temperature fluorescence spectra of the germanium microspheres prepared by Embodiment 1 and Embodiment 2 both show a right shift, indicating that their direct bandgap energy decreases under stress. Moreover, under compressive stress, the characteristic peak value of the room temperature fluorescence spectrum of the germanium microsphere at 0.94 eV shows bandgap splitting, forming a new fluorescence spectrum characteristic peak, which enhances the possibility of direct electron transition in germanium material, and can even induce the transformation of germanium material from an indirect bandgap semiconductor to a direct bandgap semiconductor.

It needs to be specially pointed out that this embodiment uses the semiconductor three-dimensional micro/nanostructure processed through Embodiment 1 in order to facilitate the comparison of semiconductor bandgap characteristics and the subsequent preparation of semiconductor three-dimensional micro/nanostructures. However, this embodiment is not limited to using processed semiconductor three-dimensional micro/nanostructures; unprocessed semiconductor optical fibers can also achieve the purpose of adjusting the bandgap by using this method.

Embodiment 3: A method for preparing the semiconductor three-dimensional micro/nanostructure with tunable bandgap, which results in a semiconductor three-dimensional micro/nanostructure with tunable bandgap, selectable shape, and controllable size.

Embodiment 3 is explained using the optical fiber with pure silicon as the fiber core and silica as the cladding as an example. Since hydrofluoric acid can corrode silica but does not easily react chemically with some semiconductors, the cladding can be effectively removed through hydrofluoric acid corrosion while maintaining the structural integrity of the semiconductor three-dimensional micro/nanostructure. Subsequently, through washing to remove residual hydrofluoric acid and its reaction products, a group of independent semiconductor three-dimensional micro/nanostructures with tunable bandgap can be obtained.

As shown in FIG. 6, FIG. 6 is an optical microscope image of an independent silicon microsphere, the diameter of which is approximately 126 μm.

The silicon microsphere is prepared by optical fiber with silicon core through a laser spot size of 1000 μm, laser power of 25 W, and optical fiber moving speed of 5 μm/s.

The larger the diameter of the fiber core, the larger the size of the semiconductor three-dimensional micro/nanostructure. According to the requirements, different diameter sizes of fiber cores can be selected, and the size of the semiconductor three-dimensional micro/nanostructure prepared by the preparation method of Embodiment 1 will be different accordingly. Due to the high symmetry of the spherical structure, the internal stress generated is more stable, therefore, the semiconductor microspheres is easier to achieve precise size control. The calculation formula for the diameter of the semiconductor microsphere is as follows:

$$d \approx D \cdot \sqrt[3]{\frac{3}{4} {v}_{f} \frac{{μ}_{p}^{clad}}{{γ}_{p}}} ;$$

wherein d is the diameter size of the semiconductor microsphere, D is the diameter size of the fiber core d, V_{f} is the moving speed of the optical fiber,

$${μ}_{p}^{clad}$$

is the viscosity magnitude of the cladding at the heating temperature, γₚ is the interfacial tension existing between the cladding and the fiber core at the heating temperature.

Therefore, semiconductor three-dimensional micro/nanostructures with tunable bandgap, selectable shape, and controllable size can be achieved. Through precise control of the size of semiconductor three-dimensional micro/nanostructures, fine regulation of material properties can be achieved. Independent semiconductor three-dimensional micro/nanostructures, while maintaining a state of stress, can be integrated into electronic devices, thereby satisfying the diverse requirements of semiconductor materials with different bandgaps in various application fields.

It can be understood that the present disclosure uses a laser to heat and process an optical fiber partially with a semiconductor fiber core, and anneals it through a tubular furnace, finally releasing a semiconductor three-dimensional micro/nanostructure from the optical fiber. The present disclosure achieves bandgap regulation of the semiconductor bandgap structure by controlling the cooling rate of the heating source and introducing different types and sizes of stress. The resulting semiconductor three-dimensional micro/nanostructure can serve as an independent three-dimensional optical and acoustic metamaterial, suitable for the construction of electronic devices.

Those skilled in the art can easily understand that the above description is only a preferred embodiment of the present disclosure and is not intended to limit the present disclosure. Any modifications, equivalent substitutions, and improvements made within the spirit and principle of the present disclosure should be included in the scope to be protected by the present disclosure.

What is claimed is:

1. A method for preparing a semiconductor three-dimensional micro/nanostructure with tunable bandgap, comprising:
heating a semiconductor optical fiber according to a target heating temperature, and controlling a cooling rate of the optical fiber during cooling, wherein a heating process and the cooling rate have a corresponding relationship with a stress applied to a fiber core and the semiconductor three-dimensional micro/nanostructure in the optical fiber, the stress is able to tune the bandgap of the semiconductor three-dimensional micro/nanostructure;
wherein in a situation where the target heating temperature is higher than a melting point of the fiber core, the optical fiber is partially heated to apply a compressive stress to the fiber core and form the semiconductor three-dimensional micro/nanostructure; in a situation where the target heating temperature is lower than the melting point of the fiber core, the whole optical fiber is heated to recrystallize the semiconductor three-dimensional micro/nanostructure, and a volume difference between a recrystallized structure and an original structure is utilized to apply a tensile stress to the semiconductor three-dimensional micro/nanostructure, and a bandgap structure is tuned.

2. The method for preparing the semiconductor three-dimensional micro/nanostructure with tunable bandgap according to claim 1, wherein the heating of the semiconductor optical fiber according to the target heating temperature, and controlling the cooling rate when cooling the optical fiber comprises:
heating a target area by a first heating source, wherein during the heating process, the optical fiber enter and leave the target area according to a target moving speed, so as to make the fiber core to form into the semiconductor three-dimensional micro/nanostructure, the target area and the optical fiber are located in a same horizontal plane, the target heating temperature specifically refers to a temperature at a center of the target area, which is higher than the melting point of the fiber core of the optical fiber, the optical fiber has a first cooling rate in a process of leaving the target area.

3. The method for preparing the semiconductor three-dimensional micro/nanostructure with tunable bandgap according to claim 2, wherein in a situation where the first heating source conducts uniform heating to the target area, a shape of the semiconductor three-dimensional micro/nanostructure is spherical;
in a situation where the first heating source conducts non-uniform heating to the target area, the shape of the semiconductor three-dimensional micro/nanostructure is non-spherical.

4. The method for preparing the semiconductor three-dimensional micro/nanostructure with tunable bandgap according to claim 2, wherein the first heating source is a laser, and before heating the target area through the first heating source, the method further comprises:
adjusting a height of the laser to determine a spot size formed by a laser emitted from the laser in the target area, wherein the spot size affects the cooling rate, where the smaller spot size results in the faster first cooling rate.

5. The method for preparing the semiconductor three-dimensional micro/nanostructure with tunable bandgap according to claim 4, further comprising:
acquiring an image of the optical fiber in the target area;
displaying the image and receiving a target input, wherein the image is used to calculate and quantify a numerical value of the cooling rate utilizing a blackbody radiation principle, and the target input is used to indicate an adjustment amount of a moving speed and an adjustment amount of an laser power;
in response to the target input, based on the adjustment amount of the moving speed and the adjustment amount of the laser power, a target moving speed of the optical fiber and the laser power are controlled.

6. The method for preparing the semiconductor three-dimensional micro/nanostructure with tunable bandgap according to claim 2, further comprising: through a moving stage carrying the optical fiber, the moving stage is used to carry the optical fiber and move the optical fiber at a target speed during the process of heating the target area by the first heating source.

7. The method for preparing the semiconductor three-dimensional micro/nanostructure with tunable bandgap according to claim 1, wherein the heating of the semiconductor optical fiber according to the target heating temperature and controlling the cooling rate when cooling the optical fiber comprises:
through a second heating source, the optical fiber processed by the first heating source is heated overall to recrystallize the semiconductor three-dimensional micro/nanostructure in the optical fiber, a target heating temperature provided by the second heating source for the optical fiber is lower than the melting point of the fiber core, the overall heating process comprises a temperature rising stage from a preset temperature to the target heating temperature, a temperature maintaining stage, and a temperature decreasing stage from the target heating temperature to the preset temperature, the temperature decreasing stage has a second cooling rate.

8. The method for preparing the semiconductor three-dimensional micro/nanostructure with tunable bandgap according to claim 7, wherein the second heating source is a tubular furnace;
the tubular furnace is utilized to hold the optical fiber containing the semiconductor three-dimensional micro/nanostructure after being processed by the first heating source, and in a vacuum environment, a temperature inside the furnace is adjusted according to a target furnace temperature, a heating rate, a cooling rate, and a holding time, where the target furnace temperature is the target heating temperature, and the cooling rate is the second cooling rate.

9. A device for preparing a semiconductor three-dimensional micro/nanostructure with tunable bandgap, comprising: a carrier and a heating module;
wherein the carrier is configured for placing an optical fiber;
the heating module is provided to performing heating according to a target heating temperature, and control a cooling rate when the optical fiber is cooled, a heating process and the cooling rate have a corresponding relationship with a stress applied to a fiber core and the semiconductor three-dimensional micro/nanostructure in the optical fiber, the stress is able to tune the bandgap of the semiconductor three-dimensional micro/nanostructure;
wherein in a situation where the target heating temperature is higher than a melting point of the fiber core, the optical fiber is partially heated to apply a compressive stress to the fiber core and form the semiconductor three-dimensional micro/nanostructure; in a situation where the target heating temperature is lower than the melting point of the fiber core, the whole optical fiber is heated to recrystallize the semiconductor three-dimensional micro/nanostructure, and a volume difference between a recrystallized structure and an original structure is utilized to apply a tensile stress to the semiconductor three-dimensional micro/nanostructure, and the bandgap structure is tuned.

10. A semiconductor three-dimensional micro/nanostructure, wherein the semiconductor three-dimensional micro/nanostructure is obtained by applying the method of preparing the semiconductor three-dimensional micro/nanostructure with tunable bandgap according to claim 1.
